(19) United States
(12) Patent Application Publication
(10) Pub. No.: US 2013/0048455 A1
(43) Pub. Date: Feb. 28, 2013

(54) CRASH BOX FOR A MOTOR VEHICLE

(71) Applicants: Thomas Friedrich, Freiberg A.N. (DE); Sven Robert Raisch, Stuttgart (DE)

(72) Inventors: Thomas Friedrich, Freiberg A.N. (DE); Sven Robert Raisch, Stuttgart (DE)

(21) Appl. No.: 13/581,297

(22) PCT Filed: Feb. 11, 2011
(86) PCT No.: PCT/EP11/52011

§ 371 Date: Nov. 5, 2012

(30) Foreign Application Priority Data
Feb. 26, 2010 (DE) 102010018316.4

(51) Int. Cl. B60R 19/34; F16F 7/12

(52) U.S. Cl. 188/377

(57) ABSTRACT

A crash box for a motor vehicle, having at least one crash box component which is deformable in the event of a collision, and which in the event of a collision absorbs energy as a result of the deformation. The crash box includes at least one weakening tool which, for adjusting the energy absorption capability of the crash box component, weakens the overall structure of the at least one crash box component, as a result of which the rigidity of the crash box component is reducible.

### FIELD OF THE INVENTION

The present invention is directed to a crash box for a motor vehicle.

### BACKGROUND INFORMATION

A crash box for a motor vehicle is described in European Patent No. EP 1 792 786 A2. A crash box is provided for integration between a bumper crossbeam and a longitudinal chassis beam of the motor vehicle, and has a housing-like deformation profile as a folded structure made of sheet metal, as well as a flange plate on the side of the longitudinal chassis beam, the flange plate being designed as an integral part of the folded structure. In the event of a collision, the crash box absorbs energy due to the deformation of the deformation profile; however, the energy absorption capability of the crash box is not adjustable.

A crash box for a motor vehicle is described in German Patent Application No. DE 10 2006 058 604 A1. The crash box includes two crash box components which are situated between two support plates and are movable relative to one another in the event of a collision. A first crash box component is designed as a deformation profile which is situated between two support plates and is enclosed by the second crash box component, which is designed as a shell. In the event of a collision, the shell is turned inside out in the area of one support plate, so that a portion of the collision energy is absorbed due to the shell being turned inside out. In addition, deformation work is performed in the area of the deformation profile, in that the deformation profile is shortened by folding.

A crash box in the form of an impact absorber is described in German Patent No. DE 100 14 469 A1, the crash box being situated between a longitudinal chassis beam and a crossbeam in a bumper of a motor vehicle. The crash box has a deformation profile, designed as a hollow body, having a ribbing which extends transversely with respect to a longitudinal axis, the deformation profile being composed of two half shells.

An energy absorption device for vehicles is described in German Patent Application No. DE 20 2007 006 376 U1, and includes a vehicle part and a metal-cutting unit, the vehicle part being machinable by the metal-cutting unit in order to absorb the energy.

### SUMMARY

The crash box according to the present invention may have the advantage that the crash box includes at least one weakening tool which, for adjusting the energy absorption capability of the crash box component, weakens the overall structure of the at least one crash box component, thus reducing the rigidity of the crash box component. As the result of the rigidity of the crash box being designed in an adaptive manner, the rigidity is adaptable prior to or during the collision, so that the energy absorption capability of the front end of the vehicle is advantageously adjustable. It is thus advantageously possible to adapt the crash box to collisions with various objects. If, for example, a pedestrian is recognized as the object, the weakening tool is able to weaken the overall structure of the crash box component to a greater extent than for a collision with a second vehicle. Another advantage is the high level of adaptivity of this type of system, since the principle may be applied to various shapes of crash boxes. The energy absorption characteristic of the crash box is changeable in a targeted manner during a head-on collision, and may be appropriately adjusted, depending on the type of collision, by providing the crash box with a “soft” setting under the key term “protection of other road users,” for example in a collision with a lightweight vehicle or a pedestrian, and by providing the crash box with a “hard” setting under the key term “self-protection,” for example in a collision with a heavy vehicle. Both properties, the protection of other road users as well as self-protection, are advantageously combined in the collision compatibility. This combination advantageously represents a high level of self-protection with a low level of aggressiveness toward pedestrians and motorists, but an improvement in the compatibility is not at the expense of the self-protection of the vehicle.

In the crash box according to the present invention, energy is advantageously absorbed as the result of two physical operating principles, namely, on the one hand by cutting work and on the other hand by plastic deformation. This allows a higher level of absorbed energy with little installation space requirement or installation size of the crash box, with weight savings at the same time. Of course, the adaptivity of the crash box may also be achieved only by the cutting work.

It is particularly advantageous that an evaluation and/or control unit in the motor vehicle for adaptively adjusting the energy absorption capability of the crash box component evaluates data of a sensor system which include information concerning the vehicle surroundings and/or the severity of a collision. An advantage lies in an arbitrarily adjustable and variable energy absorption capability of the crash box component. The weakening of the overall structure of the crash box component may be adjusted in a targeted manner as a function of a recognized object, the collision speed of the motor vehicle relative to the object, and/or the type of collision. A variable adaptation of the energy absorption by the crash box of a vehicle, and therefore optimal influencing of the reduction in the speed of the motor vehicle for better protection of the occupants of the host vehicle and of other road users, is thus advantageously possible. With the aid of this principle it is possible to allow a completely variable, and in the ideal case, continuous, adjustment of the energy absorption capability of the crash box component or crash box, and to adjust the energy absorption capability, in particular also while driving, as a function of the collision, occupant, interior, and/or driving situation.

In one example embodiment of the present invention, a sensor unit situated in the area of the crash box component ascertains the speed with which the crash box component deforms in the event of a collision, and transmits this information to the evaluation and/or control unit, which controls, preferably via an actuator unit, the at least one weakening tool as a function of the ascertained speed. The energy absorption capability of the crash box component is adjusted in a targeted manner. A quick and accurate adjustment of the weakening tool is made possible, as a result of which the rigidity of the crash box component is adjustable in a targeted manner. This advantageously results in an optimal individual adaptation of the crash box to the circumstances during a collision that is actually occurring.

In another example embodiment of the present invention, the at least one weakening tool is situated outside the crash box component and acts on an outer wall of the crash box component, and/or is situated in a cavity in the crash box component and acts outwardly on an inner wall of the crash box component. A variable adjustment of the energy absorption capability of the crash box component, i.e., a variable weakening of the overall structure of the crash box component, is thus advantageously provided in that a targeted destruction of the outer wall and/or of the inner wall of the crash box component takes place. A significant advantage of this embodiment is a predictive force characteristic which may be incorporated into the crash box component. This means that, depending on the severity of a collision, a more or less deep penetration of the weakening tool into the crash box component may occur. As a result of the arrangement of the weakening tool within the crash box component, an installation space- and cost-saving design of the crash box results from making practical use of the installation space, which is present anyway, preferably for accommodating the weakening tool.

To increase the rigidity of the crash box component, the outer wall and/or the inner wall of the crash box component may have at least one reinforcement geometry. The cutting work on the one hand, and the rigidity of the deformable crash box component on the other hand, may be advantageously influenced via the shape of the ribs.

In another example embodiment of the present invention, the outer wall and/or the inner wall of the crash box component is/are at least partially mechanically destroyed by the at least one weakening tool in the event of a collision in order to weaken the crash box component. This results in a cost-effective and simple implementation of the adjustment of the energy absorption capability of the crash box component, since an implementation of the crash box according to the present invention is possible using simple weakening principles.

In another example embodiment of the present invention, the at least one weakening tool includes at least one destruction element and the actuator unit which controls the destruction element, the number of destruction elements used being variable as a function of the desired energy absorption capability of the crash box component. In addition, an adaptation of the weakening tool, with respect to the number as well as the positioning of the destruction elements, to the constraints imposed by the installation space limitations is thus advantageously possible. In particular, an optimal adjustment of the weakening tool with regard to positioning and the resulting cutting force of the destruction elements are possible due to the control of the destruction elements by the actuator unit.

In another embodiment of the present invention, the at least one destruction element is designed as an element, preferably as a blade element, having shearing and/or plastically deforming effects, whose cutting angle and/or penetration depth is/are variably adjustable via the actuator unit as a function of the desired energy absorption capability of the crash box component. The crash box component is inwardly and/or outwardly destroyed or weakened in a targeted manner by the blade element, whose cutting angle and/or penetration depth is/are preferably variably adjustable.

The weakening tool is advantageously activatable prior to and/or during the collision event. A controlled adjustment of the rigidity of the crash box component is thus possible in the event of a collision. For a greater weakening of the overall structure and a resulting reduction in the rigidity of the crash box component, the crash box or the crash box component may be more intensely deformed. For a lesser weakening of the overall structure and a resulting lesser reduction in the rigidity of the crash box component, the crash box or the crash box component may be less intensely deformed.

The crash box component is preferably an integral part of a bumper system. An adaptive front end structure is thus advantageously provided whose energy absorption capability is adaptable to the collision event in that the rigidity of the crash box component has an adaptive design. The rigidity of the crash box component of the crash box is adapted prior to or during the collision, thus ensuring a higher energy absorption capability of the front end structure. In practice, this means that, for example, a soft front end structure is settable if a pedestrian intrudes, or a harder front end structure is settable if a vehicle intrudes. The crash box is thus advantageously usable in the area of protection of other road users, for example pedestrian protection, and in the area of self-protection.

One exemplary embodiment of the present invention is illustrated in the figures and explained in greater detail below.

### BRIEF DESCRIPTION OF THE DRAWINGS

FIG. 1 shows a schematic top view of a bumper system of a motor vehicle having two crash boxes in accordance with an example embodiment of the present invention.

FIG. 2 shows a perspective illustration of one exemplary embodiment of a crash box according to an example embodiment of the present invention, having a crash box component which has a weakening tool for adjusting the energy absorption capability of the crash box component.

FIGS. 3a to 3c each show a sectional illustration of another specific embodiment of the crash box component having a reinforcement geometry situated in an outer wall of the crash box component.

FIGS. 4a and 4b each show a sectional illustration of another specific embodiment of a destruction element of the weakening tool.

FIG. 5 shows a diagram illustrating possible force levels over the course of a deformation of the crash box component of an adaptive crash box according to an example embodiment of the present invention.

FIG. 6 shows a schematic block diagram of a crash box system having a crash box according to an example embodiment the present invention.

### DETAILED DESCRIPTION OF EXAMPLE EMBODIMENTS

In the course of developments of passive safety in motor vehicles, the primary focus is initially self-protection. This is the characteristic of the motor vehicle to protect its own occupants in vehicle-vehicle collisions as well as in collisions with other objects. Crash boxes, for example, among other things, are used for this purpose. These types of crash boxes for motor vehicles are conventional, and are usually provided for placement between a bumper system and the body of the motor vehicle. The crash box is designed to absorb energy from an impact of the motor vehicle in the event of a collision in order to protect parts of the motor vehicle and the occupants of the motor vehicle. The crash box is generally designed in such a way that for an impact at a very low speed of the motor vehicle, the crash box is only reversibly deformed so that no damage to the motor vehicle occurs. For an impact at a slightly higher speed, the crash box advantageously absorbs so much energy that only the bumper system is damaged, but not the remaining body of the motor vehicle. However, in the development of crash boxes, in addition to occupant protection there is an increasing focus on issues concerning protection of other road users and collision compatibility. “Protection of other road users” is the characteristic of the motor vehicle to protect the occupants of the other vehicle in a vehicle-vehicle collision, i.e., to have the lowest possible level of aggressiveness.

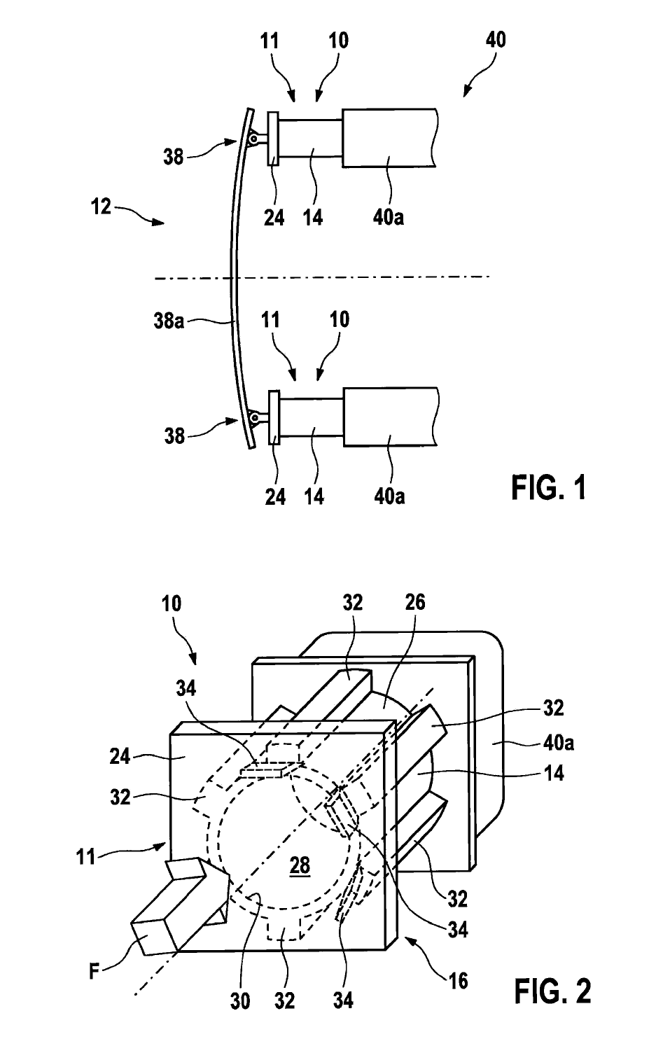

FIG. 1 illustrates a bumper system 38 of a motor vehicle 12 which is connected to a body 40 of motor vehicle 12. Body 40 has, for example, multiple longitudinal chassis beams 40a to which bumper system 38 is connected. Bumper system 38 has a crossbeam 38a which is connected to longitudinal chassis beams 40a of body 40. In the event of a collision, the forces which occur during an impact of motor vehicle 12 are introduced as uniformly as possible into body 40 of motor vehicle 12 via crossbeam 38a of bumper system 38, via the connecting points thereof to longitudinal chassis beams 40a.

As illustrated in FIG. 1, crossbeam 38a of bumper system 38 is connected to longitudinal chassis beams 40a of body 40 via a crash box system 11 having two crash boxes 10, which are attached on the one hand to crossbeam 38a of bumper system 38, and on the other hand to corresponding longitudinal chassis beam 40a of body 40. Body 40 of motor vehicle 12 preferably has two longitudinal chassis beams 40a, one longitudinal chassis beam 40a being situated in each case in a lateral border area of motor vehicle 12, and a crash box 10 being attached to each longitudinal chassis beam 40a. A crash box system 11 having two crash boxes 10 is illustrated in FIG. 1 as an example, although crash box systems 11 having only one crash box 10 or more than two crash boxes 10 are also possible.

FIG. 2 shows a perspective illustration of a crash box 10 according to the present invention for a motor vehicle 12. In the present exemplary embodiment, crash box 10 according to FIG. 1 is an integral part of a bumper system 38 of a motor vehicle 12. Crash box 10 includes a crash box component 14 which is deformable in the event of a collision, and which may be designed either as part of body 40 or as a separate component that is fixedly connected to body 40. As a result of deformation d of crash box component 14, in the event of a collision at least a portion of collision energy F is absorbed by the deformation work. In the present exemplary embodiment, crash box component 14 preferably has a tubular, i.e., hollow, design. Other geometries, for example conical, cylindrical, cylindrical with an elliptical cross section, or rectangular or square shapes are also possible.

In order to adapt a crash box 10 to the circumstances present in the event of a collision, such as severity of a collision and/or intrusion speed, for example, according to an example embodiment of the present invention crash box 10 has at least one weakening tool 16, which for adjusting the energy absorption capability of crash box component 14 weakens the overall structure of the at least one crash box component 14, thus reducing the rigidity of crash box component 14. An adaptation of the rigidity, i.e., the absorption of collision energy F of crash box 10, is thus advantageously achieved in that, on the one hand, energy is absorbed due to weakening work, and on the other hand, the rigidity of crash box component 14 of crash box 10 is influenced by weakening the overall structure of crash box component 14, and the energy absorption is thus likewise influenced. In this regard it is worth mentioning that, depending on the design of weakening tool 16 and the properties of crash box component 14, more energy is absorbed by influencing the rigidity of crash box component 14 of crash box 10 than by the absorption of energy due to the weakening work.

In the present exemplary embodiment, weakening tool 16 is situated outside crash box component 14, and acts on an outer wall 26 of crash box component 14. Alternatively, weakening tool 16 may be situated in a cavity 28 in crash box component 14 and act outwardly on an inner wall 30 of crash box component 14. This means that in this alternative design, weakening tool 16 is integrated into crash box component 14. In the event of a collision, outer wall 26 or alternatively inner wall 30 of crash box component 14 is at least partially mechanically destroyed in order to weaken crash box component 14.

In the present exemplary embodiment, weakening tool 16 includes at least one destruction element 34, 34a, 34b and an actuator unit 24 which controls destruction element 34, 34a, 34b, the number of destruction elements 34, 34a, 34b used being variable as a function of the desired energy absorption capability of crash box component 14. Destruction element 34, 34a, 34b of weakening tool 16 is controlled in a controlled manner by actuator unit 24 shown in FIG. 6.

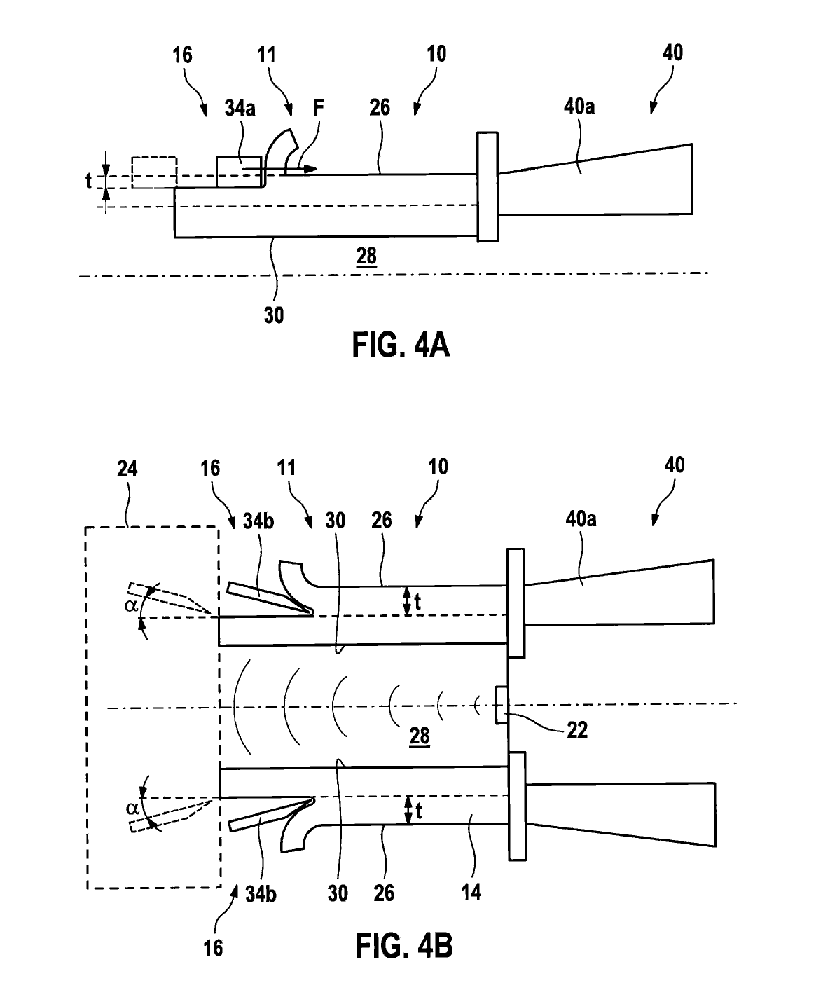

Actuator unit 24 is responsible for changing the adjustment of destruction element 34, 34a, 34b, the number of actuator units 24 used and of destruction elements 34, 34a, 34b used being adaptable to the various requirements. The number may be different depending on the dimensioning or the vehicle size, for example. The main requirement for actuator unit 24 is rapidity. Destruction element 34, 34a, 34b is preferably settable or adjustable in a continuously variable manner, although adjustment in multiple steps is likewise possible if increased rapidity is thus achieved. Cutting angle α as well as penetration depth t of destruction element 34, 34a, 34b may be changed by actuator unit 24, as illustrated in FIGS. 4a and 4b. Cutting angle α and/or penetration depth t of destruction elements 34, 34a, 34b may be changed prior to deformation d of crash box 10. It is also possible to change the rigidity of crash box 10 during the collision.

Actuator unit 24 may be mounted, for example, on crossbeam 38a of bumper system 38, or inside crash box component 14 on the side of crossbeam 38a or on longitudinal chassis beam 40a of body 40, or inside crash box component 14 on the side of longitudinal chassis beam 40a of motor vehicle 12.

In the present exemplary embodiment, destruction elements 34, 34a, 34b are preferably designed as blade elements whose penetration depth t according to FIG. 4a and/or cutting angle α according to FIG. 4b is/are variably adjustable via actuator unit 24 as a function of the desired energy absorption capability of crash box component 14, a small cutting angle α meaning that blade element 34, 34a, 34b has a “flat” setting, and therefore little material is removed. As the result of using destruction elements 34, 34a, 34b spaced at regular intervals, weakening tool 16 exerts its effect symmetrically, and is thus able to affect a large surface area of crash box component 14.

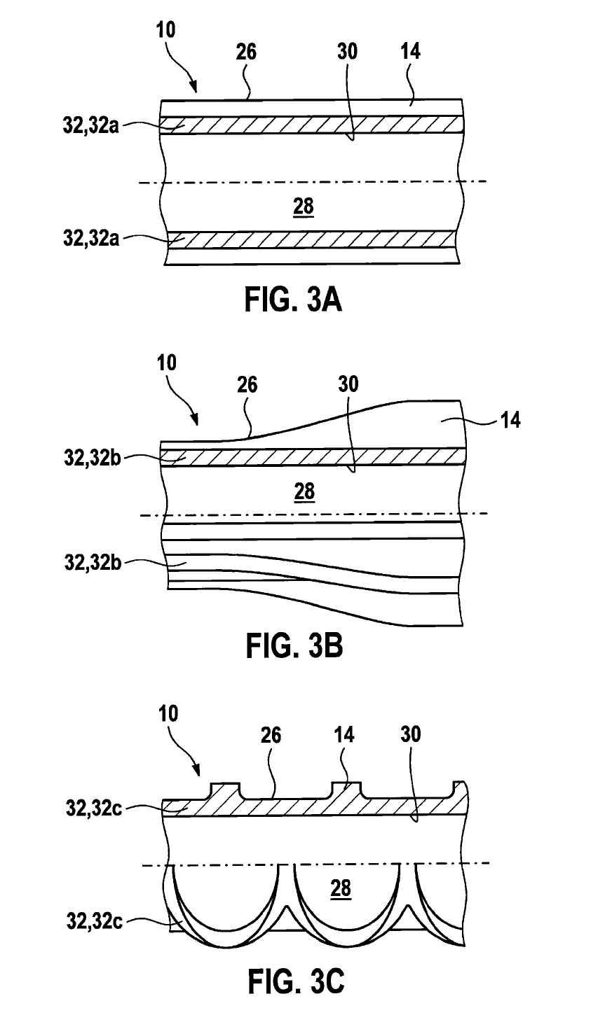

Deformable crash box component 14 is used for absorbing collision energy F as the result of being plastically and irreversibly deformed. To increase the rigidity of crash box component 14, outer wall 26 and/or inner wall 30 of crash box component 14 has/have at least one reinforcement geometry 32, 32a, 32b, 32c. In the present exemplary embodiment, reinforcement geometry 32 involves ribs 32a, 32b, 32c having various shapes. The ribs may, for example, have the shape of longitudinal ribs 32a according to FIG. 2 and FIG. 3a, longitudinal ribs 32b having a variable cross section according to FIG. 3b, and ribs 32c which intersect one another according to FIG. 3c. On the one hand the cutting work, and on the other hand the rigidity of deformable crash box component 14, may be influenced by the shape of ribs 32a, 32b, 32c. The quality of the adjustment of the energy absorption capability of crash box component 14 may be influenced via the material pairing of crash box component 14 and blade elements 34, 34a, 34b. Crash box component 14 is preferably made of plastic, although other materials are also possible. The design of crash box component 14 as a material composite is also possible. Possible specific embodiments include, for example, two-component parts made of plastic having a so-called “hard” material for the rigidity and a so-called “soft” material for the cutting work, or also metal-plastic combinations. Multiple concentrically arranged cylinders made of various materials, for example, may also be used. Instead of local reinforcement ribs, crash box component 14 may have a generally greater wall thickness. This advantageously allows simpler and therefore more cost-effective manufacture, as well as easier installation of the crash box system.

FIGS. 3a through 3c show different specific embodiments of crash box component 14. FIG. 3a shows a crash box component 14, designed as a tube, having longitudinal ribbing 32a. FIG. 3b shows a crash box component 14, designed as a tube, having longitudinal ribbing 32b and a cross section which increases in thickness. FIG. 3c shows a crash box component 14, designed as a tube, having longitudinal ribs 32c which intersect one another. Longitudinal ribs 32c intersect diagonally, resulting in different strength properties of crash box component 14. Blade elements 34, 34a, 34b produce notches in ribs 32c during the cutting.

FIG. 6 shows a schematic block diagram of a crash box system 11 of a motor vehicle 12 having a crash box 10 according to the present invention. As is apparent from FIG. 6, motor vehicle 12 has a sensor system 20, an evaluation and/or control unit 18, and crash box system 11 which has the at least one crash box 10, weakening tool 16, and actuator unit 24, whereby crash box system 11 according to FIG. 1 is situated between bumper system 38 and body 40 of motor vehicle 12.

Sensor system 20 senses information concerning vehicle surroundings, a severity of a collision, and/or vehicle dynamics variables. A sensor unit 22 situated in the area of crash box component 14 ascertains the speed with which crash box component 14 deforms in the event of a collision, and transmits the information to evaluation and/or control unit 18, which controls the at least one weakening tool 16, preferably via actuator unit 24, as a function of the ascertained speed. Evaluation and/or control unit 18 receives the detected information from sensor system 20 and/or from sensor unit 22, and evaluates the received information for adaptively adjusting the energy absorption capability of crash box component 14, evaluation and/or control unit 18 evaluating the ascertained instantaneous driving situation in terms of whether or not it is necessary to activate weakening tool 16 of crash box system 11. The received information concerning vehicle dynamics variables together with the information from the vehicle surroundings and/or the crash box zone allow evaluation and/or control unit 18 to carry out anticipatory control of weakening tool 16. The control may also be carried out as a function of information which the vehicle receives via a communication system from the outside, i.e., from other motorists, traffic control centers, etc.

Sensor unit 22 is preferably designed as a speed measuring device, for example as a radar unit, which is integrated into crash box 10. In addition to the low costs, sensor unit 22 also provides further prerequisites for meeting the requirements for accuracy and rapidity in adjusting weakening tool 16. This small radar sensor 22 is able to very accurately determine in one dimension, in the present case in the axial direction, the distance as well as the change in distance, i.e., the speed, at a very high sampling rate. Thus, the speed with which crash box 10 initially deforms may be ascertained at a very early point in time after the collision. As previously mentioned, sensor system 20, which preferably is designed as a pre-collision sensor and/or communication system, may also provide the input for adjusting crash box 10. Thus, the signal could also come from a mono or stereo video sensor system, a radar sensor, a LIDAR sensor, or a closing velocity (CV) sensor, and/or via a communication system from the outside, i.e., from other motorists, traffic control centers, etc. As a result, so-called upfront sensors currently used in the front end of motor vehicles 12 could advantageously either be spared, or directly integrated into crash box 10.

Weakening tool 16 may be controlled as a function of a signal from evaluation and/or control unit 18. Evaluation and/or control unit 18 is preferably designed in the form of a control unit designed as an airbag control unit, for example, other control units for the control also being conceivable. Evaluation and/or control unit 18 is preferably designed as part of the airbag control unit, which results in cost savings. A design of evaluation and/or control unit 18 as a separate control unit would advantageously allow a higher degree of modularity. However, this type of separate intelligence would have to be placed in such a way that it is protected during a collision. As stated above, evaluation and/or control unit 18 provides for the detection of information from sensor system 20 and/or sensor unit 22; i.e., for adaptively controlling weakening tool 16, evaluation and/or control unit 18 of motor vehicle 12 evaluates data of sensor system 20 and/or of sensor unit 22 which include information concerning the vehicle surroundings and/or the severity of a collision, and/or the speed with which crash box component 14 deforms in the event of a collision. With the aid of an evaluation algorithm, an appropriate signal is generated which controls, via actuator unit 24, weakening tool 16 as a function of the ascertained information. Crash box 10 according to the present invention preferably provides the option for acting on weakening tool 16 not only prior to or shortly after the collision, but also during the entire collision process, with feedback.

Prior to and during the collision, sensor system 20 senses information concerning vehicle surroundings, an impact, and/or vehicle dynamics variables, and for controlling weakening tool 16 of crash box 10 transmits a corresponding control signal to actuator unit 24. The signal may be a voltage and/or an information item such that actuator unit 24 generates an actuating signal for destruction elements 34, 34a, 34b, 34c which acts on crash box component 14 with cutting angle α specified via the actuating signal, and/or with penetration depth t specified via the actuating signal.

Weakening tool 16 is preferably activatable prior to and/or during the collision event. If anticipatory sensor system 20 recognizes a potential impact, actuator unit 24 activates destruction elements 34, 34a, 34b, 34c of weakening tool 16, whereby the intensity of the weakening of the overall structure of crash box component 14, or cutting angle α and/or penetration depth t of destruction elements 34, 34a, 34b, 34c, may be adjusted in a targeted manner by actuator unit 24, preferably as a function of a recognized object, the relative speed of the vehicle, the speed with which crash box component 14 deforms during the collision event, and/or the type of collision. Adaptive crash box 10 according to the present invention is designed in such a way that, in the event of an error, one may always resort to the maximum rigidity of crash box component 14, and thus, to the maximum self-protection. The control of weakening tool 16 is independent of any error detection by anticipatory sensor system 20, since destruction elements 34, 34a, 34b, 34c are once again switched off by actuator unit 24 after a defined period of time if a collision does not occur. The control of destruction elements 34, 34a, 34b, 34c during a collision event, and in particular during a multiple collision event, is preferably regulatable in a targeted manner and/or is constant.

The mode of operation of adaptive crash box 10 may be described by the following steps:

In a first optional step, sensor system 20, preferably a pre-collision sensor system, recognizes an imminent collision, and ideally is able to distinguish between a stationary object and a moving object. Sensor system 20 is also preferably able to determine the size of the stationary or moving object.

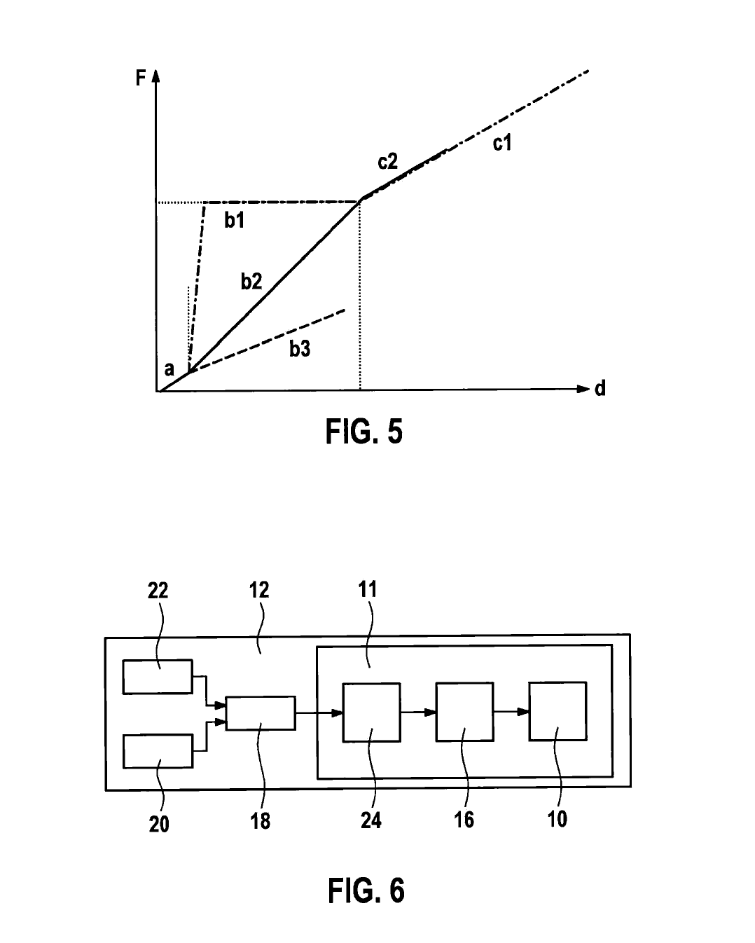

In a second step, motor vehicle 12 has contact with the object or obstruction. The deformation of the front end in the area of crossbeam 38a begins. Crossbeam 38a deforms crash box component 14 of crash box 10. Initially, deformation d is still elastic, as is apparent from curve segment a in FIG. 5. Sensor unit 22, which preferably is inside the crash box, detects deformation d and its speed in a third step. In a fourth step, evaluation and/or control unit 18 evaluates the severity of the collision and decides on the necessary rigidity, i.e., strength, of crash box 10, evaluation and/or control unit 18 being designed either as a separate control unit in the adaptive crash box or as part of an airbag control unit of the motor vehicle. In a fifth step, evaluation and/or control unit 18 outputs an appropriate signal to actuator unit 24, which adjusts or does not adjust destruction elements 34, 34a, 34b of weakening tool 16, depending on the type of collision. The plastic deformation of crash box 10 begins in a sixth step, there being different cases in this regard.

In a first case, evaluation and/or control unit 18 registers a severe collision. Use must be made of the entire rigidity of crash box 10 according to curve segment b1 in FIG. 5. Destruction elements 34, 34a, 34b of weakening tool 16 are adjusted under the key term “self-protection” in such a way that as much energy as possible is dissipated. Deformation d clearly extends beyond crash box 10. Additional energy is absorbed in longitudinal chassis beam 40a according to curve segment c1 in FIG. 5.

In a second case, evaluation and/or control unit 18 registers a collision of moderate severity. Under the key terms “collision compatibility,” “protection of other road users,” and “self-protection,” only a portion of destruction elements 34, 34a, 34b are used. The rigidity, i.e., strength, of crash box 10 is reduced in a targeted manner, and in favor of the other participant in the accident, in order to degrade the energy in the most optimal manner possible. The crash box is deformed according to curve segment b2 in FIG. 5, and a portion of longitudinal chassis beam 40a is deformed according to curve segment c2 in FIG. 5.

In a third case, evaluation and/or control unit 18 registers a minor accident. Destruction elements 34, 34a, 34b of weakening tool 16 are adjusted under the key terms “repairworthy collision,” i.e., 16 km/h against a rigid barrier, and “pedestrian protection” in such a way that only crash box 10 is deformed. According to curve segment b3 in FIG. 5, only crash box 10 is deformed, while longitudinal chassis beam 40a remains intact.

The curve progression illustrated in FIG. 5 is divided into the three segments described below. Segment a represents the initial zone of crash box 10, which is an elastic area. This characteristic is always the same, regardless of the individual crash box settings. Segment b shows different rigidity settings of crash box 10, other settings besides b1, b2, b3 being possible. Segment c represents longitudinal chassis beam 40a, which is more or less deformed (or not deformed at all), depending on the severity of a collision. This characteristic is always the same.

One important advantage of the present invention is that the adaptive crash box according to the present invention is a so-called dry system. This means that no liquids at all are used here. Since this is a dry system, elements such as hydraulic pumps, valves for adaptivity, hydraulic lines, or hydraulic accumulators, for example, may be dispensed with. In particular, there are no sealing problems over the service life of the vehicle, and also no environmental aspects concerning toxic liquids have to be taken into account. Thus, a dry approach is not only easier, but also more compact, economical, and environmentally friendly.

Another advantage of the present invention is that adaptive crash box 10 offers an optimal approach, in particular for an offset collision. The advantages of adaptive crash box 10 compared to a nonadaptive approach are particularly apparent in the offset collision. Since the system is equipped with a sensor system 20 and/or a sensor unit 22, for example a radar unit, a distinction may be made as to whether a collision with a wall, without offset (for example, USNCAP at 56 km/h) or a collision with overlap (for example, EuroNCAP at 64 km/h, 40% overlap with respect to a barrier) is involved. When there is overlap, longitudinal chassis beam 40a of body 40 and crash box 10 in question must degrade almost all of collision energy F and therefore must have a very stiff design, the adaptive crash box having a “stiff” setting. On the other hand, if both longitudinal chassis beams 40a of body 40 and both crash boxes 10 of crash box system 11 are involved, adaptive crash boxes 10 may have a “softer” setting in order to degrade more energy over the path, without causing high peak stresses.

1-10. (canceled)

11. A crash box for a motor vehicle, comprising:
at least one crash box component which is deformable in an event of a collision, and which in the event of the collision absorbs energy as a result of the deformation; and
at least one weakening tool which, for adjusting the energy absorption capability of the crash box component, weakens an overall structure of the at least one crash box component, as a result of which rigidity of the crash box component is reducible.

12. The crash box as recited in claim 11, wherein at least one of an evaluation and a control unit, in the motor vehicle, for adaptively adjusting the energy absorption capability of the crash box component are configured to evaluate data of a sensor system which include information concerning at least one of vehicle surroundings and the severity of a collision.

13. The crash box as recited in claim 12, wherein a sensor unit situated in an area of the crash box component ascertains a speed with which the crash box component deforms in the event of a collision, and transmits ascertained speed to the at least one of the evaluation and the control unit, which controls, via an actuator unit, the at least one weakening tool as a function of the ascertained speed.

14. The crash box as recited in claim 11, wherein at least one of: i) the at least one weakening tool is situated outside the crash box component and acts on an outer wall of the crash box component, and ii) the at least one weakening tool is situated in a cavity in the crash box component and acts outwardly on an inner wall of the crash box component.

15. The crash box as recited in claim 14, wherein at least one of the outer wall and the inner wall of the crash box component has at least one reinforcement geometry.

16. The crash box as recited in claim 14, wherein the at least one weakening tool at least partially mechanically destroys at least one of the outer wall and the inner wall of the crash box component in the event of a collision in order to weaken the crash box component.

17. The crash box as recited in claim 11, wherein the at least one weakening tool includes at least one destruction element and an actuator unit which controls the destruction element, a number of destruction elements used being variable as a function of a desired energy absorption capability of the crash box component.

18. The crash box as recited in claim 17, wherein the at least one destruction element is a blade element having at least one of shearing and plastically deforming effects, whose at least one of cutting angle and penetration depth is variably adjustable via the actuator unit as a function of the desired energy absorption capability of the crash box component.

19. The crash box as recited in claim 11, wherein the weakening tool is activatable at least one of prior to and during the collision event.

20. The crash box as recited in claim 11, wherein the crash box is an integral part of a bumper system of the vehicle.
